(19) United States
(12) Patent Application Publication
(10) Pub. No.: US 2009/0327295 A1
(43) Pub. Date: Dec. 31, 2009

(54) MAINTENANCE OF EXO-FILE SYSTEM METADATA ON REMOVABLE STORAGE DEVICE

(75) Inventors: James Bovee, Redmond, WA (US); Vlad Sadovsky, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/146,024

(22) Filed: Jun. 25, 2008

(51) Int. Cl. G06F 17/30; G06F 12/14

(52) U.S. Cl. 707/9; 707/201; 707/E17.009

(57) ABSTRACT

An interface between a host computing device and a transient storage device (TSD) eliminates the need for a full directory crawl of the storage volume on the TSD to maintain a metadata database. The metadata database is incrementally updated instead of being completely regenerated on every connection between the TSD and a highly capable host. This function helps the host device more efficiently track and maintain exo-file system metadata. Host devices discover and use this new TSD function to efficiently update the metadata database. Host devices provide parameters governing the operation of the TSD to the TSD. Cooperatively, the TSD logs addresses corresponding to storage locations of changes made to the data on the storage volume and, upon discovering a capability of the host device to update the metadata database, the TSD provides discovery to the host device regarding an availability of the metadata database and the log of addresses.

### BACKGROUND

Transient storage devices (TSDS) have come into widespread use for portable computer data storage in recent years. TSDs may take the form of universal serial bus (USB) or Institute of Electrical and Electronics Engineers (IEEE) 1394 standard (FireWire) removable hard drives, flash drives, and memory cards and “sticks” for mobile phones, digital cameras, personal digital assistants, digital music players (e.g., MP3 players), and other portable devices.

Maintaining exo-file system metadata for files contained on TSDs usually requires full enumeration of the entire file directory tree whenever the TSD is connected to a host device. This ensures that all changes to the data files maintained on the TSD, which may have occurred while the TSD was disconnected from the current host, are reliably detected. For example, when a TSD is connected to a host device running Windows Shell Autoplay (“Autoplay”), Autoplay walks the entire file system tree hierarchy on the TSD to determine which content types are present on the TSD. Using this information Autoplay constructs a list of appropriate handlers for the discovered content types.

The problem can be generalized to include any application which requires aggregated storage volume metadata not made available in an efficient form by the file system of the TSD itself. Such an application must enumerate the entire contents of the TSD and redundantly regenerate the metadata index every time the device is reconnected. Not only is this redundancy a waste of time, it is also inefficient with respect to power consumption. Unfortunately, as storage capacities of TSDs increase an ever increasing amount of input/output (I/O) data transfer and time is required to create the index resulting in a negative impact on the user experience. This is a steep price to pay for accurately tracking metadata for the entire TSD, especially in cases where the storage volume has changed very little or not at all.

### SUMMARY

The processes disclosed herein provide additional functionality in the form of an interface between a host computing device and a transient storage device (TSD) that eliminates the need for a full directory crawl of the storage volume on the TSD to maintain a metadata database. Rather than completely regenerating the metadata database on every connection between the TSD and a highly capable host, the metadata database is incrementally updated. This function helps the host device more efficiently track and maintain exo-file system metadata. Accurately performing this maintenance of the exo-file system metadata, while taking into account the diversity of host systems that the TSD may connect with, requires coordination between the TSD and the host machines that are able to use this new interface functionality. Host devices are tasked with discovering and using this new TSD function and using it to efficiently update the metadata database. Host devices may also provide parameters governing the operation of the TSD to the TSD. Cooperatively, the TSD logs addresses corresponding to storage locations of changes made to the data on the storage volume and, upon discovering a capability of the host device to update the metadata database, the TSD provides discovery to the host device regarding an availability of the metadata database and the log of addresses.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of an interface between each of a highly capable host device and, alternately, a less capable host device and a transient storage device that together maintain an exo-file system metadata database of the data files stored on the transient storage device.

FIG. 2 is a flow diagram of an exemplary process performed by a transient storage device when connecting with a host device to manage an exo-file system metadata database.

FIG. 3 is a flow diagram of an exemplary process performed by a highly capable host device when connecting with a transient storage device to manage an exo-file system metadata database.

FIG. 4 is a flow diagram of an exemplary process performed by a less capable host device when connecting with a transient storage device to manage an exo-file system metadata database.

FIG. 5 is a schematic diagram of a general purpose computer system that may operate as a host device connecting to a transient storage device.

### DETAILED DESCRIPTION

A transient storage device (TSD) maintains a file system, generally in the form of a standard directory tree, of all the data files stored within a main storage volume. These data files may be of any type, for example, word processing or spreadsheet documents, music files, video files, image or picture files, or any other type of data generally saved on a storage device. Exo-file system metadata may be implemented on the TSD in the form of a database of information about the files in the main file system on the storage volume. The exo-file system metadata is maintained separately and apart from the main file system. The exo-file system metadata database helps any connecting host device to more quickly provide information about data stored on the TSD to a user of the host device without having to scan and parse all the actual data files stored in the storage volume of the TSD. An example of this functionality may be understood in the context of a digital music player (e.g., an MP3 player), which by using a metadata database can more quickly provide information to a user about songs stored on the device.

The basis for efficient management of an exo-file system metadata database is a log of written data block addresses maintained by the TSD, for example, as part of the firmware. At the request of the connected host device, the TSD may activate or de-activate this log, or filter certain address ranges to prevent their occurrence in the log. For example, a digital picture frame may only be interested in changes to image data files stored on the TSD. Each block entry in the log not accounted for by the host-maintained metadata database represents work that the host device must perform in the form of extracting the relevant metadata from the file in the file system that corresponds to this block and then updating the metadata database with that extracted metadata. Once the host device has completed an update of the metadata database, the host device may issue a request for the TSD to clear entries from the log, either partially or entirely.

There are a number of ways for the TSD to persist the log, each with its own set of trade-offs. A first of two exemplary approaches is run-length encoding (RLE) of address ranges for the log. The advantages to the RLE approach are that the blocks are of variable length and may be extended with additional data such as frequency. RLE also takes advantage of the fact that the file system favors contiguous block addresses. A second exemplary approach is to use bitmap encoding to write the log. Advantages of bitmap encoding are that the blocks are of fixed length and the format consumes only one bit per block. A disadvantage is that bitmap encoding is not extensible. To facility further size efficiency in the log, the host device may advise the TSD to write a minimum allocation unit and/or exclude certain address zones.

For the purpose of the following discussion, hosts may be separated into two categories: highly capable (HC) and less capable (LC). HC hosts (e.g., desktop computers, laptop computers, and server computers) are relatively resource-rich with large and fast processor capabilities and are easily capable of parsing large amounts of file system data and generating an exo-file system metadata database. In contrast, LC hosts (e.g., video game systems, car stereos, portable media players, digital picture frames, etc.) have limited resources with slower, smaller capacity processors and are incapable of generating such a metadata database from the file system of the TSD within a tolerable period of time. Therefore, along with database reading capability, the responsibility for generating and updating the database falls to HC hosts. LC hosts are primarily concerned with reading the metadata database, if at all. Of course exceptions to this classification may exist, however it generally applies.

For each TSD encountered by an HC host, a database of exo-file system metadata is generated and updated. This metadata database, representing the entire contents of the TSD, is persisted on and travels with the TSD itself, either within the file system as a file or outside the file system, accessed as an independent byte stream outside the data stream transferring the primary data files from the storage volume. The metadata database may be consumed either by the currently connected host device, other future connected host devices, or even by the TSD itself if the TSD can be independently operated by a user while disconnected from a host machine (e.g., a personal digital assistant or smart phone that regularly creates and stores data files (e.g., contact information) and also functions as an MP3 player).

In an exemplary implementation, when an HC host device first connects with a TSD, an updater application on the HC host device may first determine whether the TSD is configured to maintain a metadata database. If the TSD does have a metadata database, the host device then determines whether the TSD supports block address logging. If so, the host device checks the log for blocks which have been written to the TSD since the metadata database was last updated. The log may be ensured to contain only entries since the prior update if the host device instructs the TSD to actively clear log entries when the metadata database is updated. For each changed data block in the log on the TSD, the host device locates the address of the data file in the file system corresponding to the changed block and processes that data file to add, remove, or update the metadata in the exo-file system metadata database. Once the metadata database is updated, the host device directs the TSD to clear the corresponding block entry or entries from the log. These operations may be performed in a transacted manner to preserve the integrity of the metadata database and block address log.

While the TSD remains connected to the current host device, the metadata database may be opportunistically updated as various applications and system components modify the contents of the TSD. Block address logging also helps to protect against loss of integrity in the case where the TSD is “surprise-removed” (i.e., removed without ensuring that read/write operations to the TSD are complete and that it is in an inactive state) from the host device during a metadata database update. As long as block address log entry removal and metadata database updates are properly transacted (as well as inter-metadata database updates), any surprise-removal of a TSD during metadata database update can at worst only result in a transient state where some metadata database records have yet to be added. However, re-connecting the TSD to the same or another HC host resumes the metadata database updating task from the same spot where it was interrupted by surprise-removal.

An HC host may be configured to maintain an additional backup copy of the metadata database in its own internal fixed storage. This copy of the metadata database may be used as an offline reference or it may serve as an integral component of a TSD synchronization mechanism. The unique serial number for the TSD (required for compliance with many storage device specifications) helps maintain a one-to-one correspondence between the backup metadata database copy and the TSD being indexed by that metadata database. As a precaution against inadvertent or malicious corruption of the metadata database, it may also be signed by the HC host device that updated the metadata database so that any consumer of data in the metadata database can first verify the authenticity of the updates as performed by the metadata database updater via a mutually trusted root before using it.

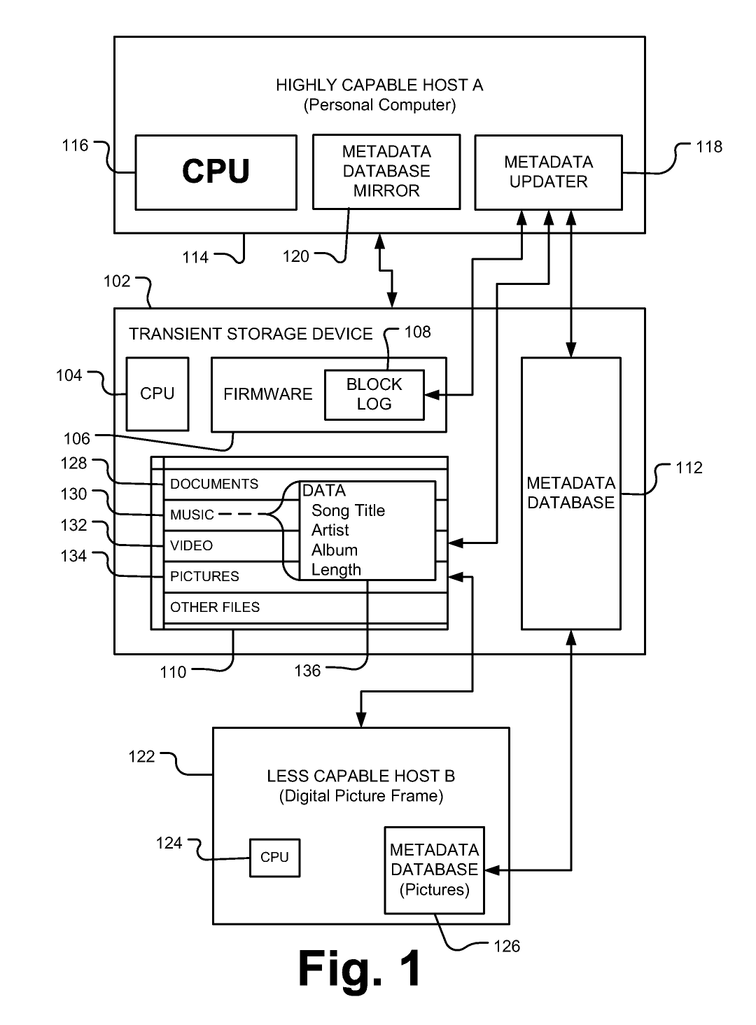

As an aid to understanding this technology, a transient storage device 102, or TSD, is depicted in FIG. 1 in conjunction with an HC host 114 and an LC host 122. The TSD 102 further includes a processor 104 operating under control of embedded firmware 106 that executes data transfer, host-device mutual authentication, and other functionality of the TSD 102. Each TSD 102 may have at least one and possibly more storage volumes 110. The TSD maintains a block address log 108 within the firmware 106 to ensure persistence of the log and prevent possible overwriting if it were a file in the standard file system. The block address log 108 records locations of all changes to data files in the standard file system on the storage volume 110 regardless of what host device the TSD 102 is connected to or even in the event that the TSD 102 is able to make changes to the storage volume itself. The TSD also maintains a metadata database 112 of the data files on the storage volume 110 separate from the storage volume.

As shown in FIG. 1, the HC host 114, which may be a personal computer, has a relatively high speed and high capacity central processor 116 along with a sufficient amount of working memory that is capable of interrogating the storage volume 110 on the TSD 102 to generate the metadata database 112. However, the user experience may be even faster if the central processor on the HC host 116 does not have to parse the entire storage volume 110 to update the metadata database 112 each time the TSD 102 connects to the HC host 114. The HC host 114 also instantiates a metadata updater program 118 when connected with the TSD 102 that may be understood as an application protocol interface that functions in conjunction with the TSD 102 to maintain the metadata database 112 in on the TSD 102. The HC host device 114 may also host a metadata database mirror 120 that the metadata updater 118 writes to the HC host 114. The metadata database mirror 120 is a copy of the metadata database 112 and may be used by the HC host device 114 to provide faster access by a user of the HC host device 114 to the metadata of the TSD 102 or to provide the user access to the metadata of the TSD 102 when the HC host device 114 is disconnected from the TSD 102.

When the HC host device 114 is connected with the TSD 102, the metadata updater 118 instantiates and interrogates the TSD 102 to determine whether the TSD 102 maintains a block address log 108 and, if so, identifies any changes to the storage volume 110 since the previous time that the metadata database 112 was updated. Thus, updates to the metadata database 112 may be performed by any highly capable host with the metadata updater 118 application when connected to the TSD 102. This ensures that ongoing updates are merely incremental and the entire storage volume does not need to be parsed each time the TSD 102 is connected to a host device.

The metadata updater 118 directs the TSD to parse the data files on the storage volume 110 associated with the block changes recorded in the log 108 and return metadata 136 regarding the file added, modified or deleted and the block address. For example, the storage volume 110 may contain a variety of data files including documents 128, music files 130, video files 132, and picture files 134. Further, presume that the log 108 indicates that a music file 130 was updated at a particular block address. The TSD 102 is directed by the metadata updater 118 to extract and synthesize any relevant metadata 136 associated with the particular music file, for example, the song title, the artist, the name of the album, and the length of the song. This metadata 136 may then be copied directly to the metadata database 112 or to the HC host device 114 for other processing and then written back to the metadata database 112 on the TSD 102.

If the HC host device 114 maintains a metadata database mirror 120 as in FIG. 1, the metadata updater 118 will need to copy the entire metadata database 112 from the TSD 102 to the HC host device 114 to ensure that changes made by another host device are reflected in the metadata database mirror 120. Alternatively, the protocol of the metadata updater 118 may maintain a record of all changes to the metadata database 112 that all host devices may consult to determine what metadata needs to be updated on any mirror databases.

In contrast, when an LC host device 122 connects with the TSD 102, the processor 124 of the LC host 122 is not powerful enough to timely manage the data parsing and transfer functions necessary to generate metadata 136 for the metadata database 112. Therefore, the LC host device 122 does not run a metadata updater program. However, the LC host device 122 may take advantage of the metadata database 112 prepared by more highly capable hosts to provide information about the data files the LC host device 122 exchanges with the TSD 102. For example, as depicted in FIG. 1, the LC host device 122 may be a digital picture frame device with limited processing capability. The firmware of the picture frame may be limited in functionality to transferring a copy of a picture file 130 from the storage volume 110 on the TSD 102 and deleting picture files previously stored on the LC host device 122. A subset 126 of the metadata database 112 may also be shared with the LC host device 122. In the example of FIG. 1, only metadata related to picture files is maintained on the digital picture frame. The picture frame may or may not have an ability to cause changes to the data files on the storage volume 110. In the event that the LC host device 122 is able to modify any of the data files on the storage volume 110 of the TSD 102, the firmware 106 of the TSD 102 will capture such changes in the form of logging storage block change entries in the block address log 108.

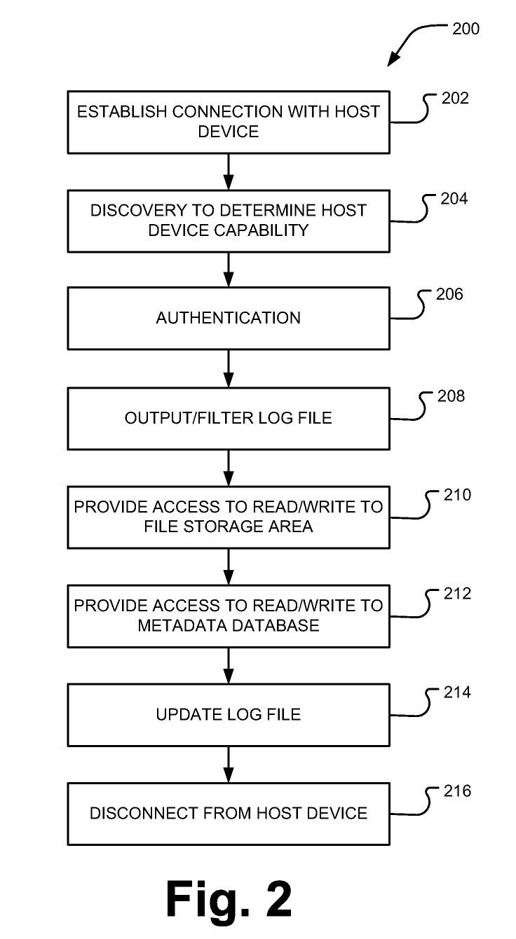

An exemplary process 200 performed by the TSD upon connection with an HC host device equipped with the metadata updater module is depicted in FIG. 2. As an initial matter, when the TSD is physically connected with the host device, a communication connection is established in establishing operation 202. The TSD then performs a discovery function to determine whether the host device is a highly capable device or a less capable device in discovery operation 204. This type of discovery informs the TSD as to what kinds of information it will need to provide to the host device, for example, whether the host device will be expecting block address log changes or has no metadata updating capabilities. Additionally, the TSD performs an authentication routine to determine whether the host device is authorized to access the data files on the storage volume and/or the metadata database as indicated in authentication operation 206. Authentication may be performed using certificates, passwords, or other forms of authentication received from the host device for comparison to certificates held by the TSD.

Once the host device is authenticated to the TSD and presuming the host device has been determined to be a highly capable device, the TSD may provide any block address changes found in the log to the metadata updater application in the host device in outputting operation 208. Alternatively, upon direction of the metadata updater, the TSD may filter or limit the change information from the log that it provides to the metadata updater program on the host device. A request for limited log information may be made, for example, if the host device is a limited function device (e.g., a digital music player) that only wants update information related to music files on the TSD.

After passing the log to the host device and under direction of the metadata updater, the TSD accesses the data files at the block addresses identified in the log and the host device extracts the relevant metadata information from modified data files for use in creating and updating the metadata database in a first providing operation 210. The TSD next provides the host device access to the metadata database by performing any read/modify/write commands instructed by the metadata updater in a second providing operation 212. The metadata updater is thus able to update the metadata database stored on the TSD with only the changes to the data files on the storage volume and thus greatly reduces the time and processing power previously needed to construct the metadata database.

Once the metadata database is updated, the metadata updater application may instruct the TSD to update the log which the TSD performs in updating operation 214. If all of the changes indicated in the log are reflected in the updates to the metadata database, then the TSD will clear all of the block address changes reflected in the log. However, if only some of the block address changes are reflected in the metadata database, for example, only those changes related to music files as in the example above, then the TSD will only remove those address blocks from the log that are reflected in the metadata database. After the log has been updated, the TSD may be disconnected from the host device as indicated in disconnecting operation 216.

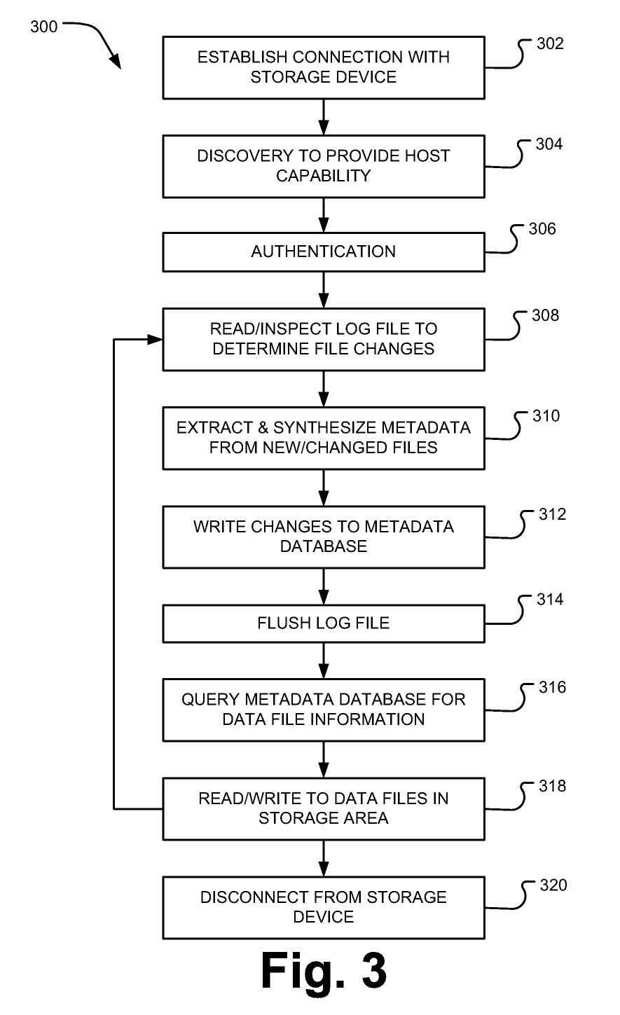

An exemplary process 300 performed by an HC host device equipped with the metadata updater module when connected with a TSD is depicted in FIG. 3. As an initial matter, when the HC host device is physically connected with the TSD, a communication connection is established in establishing operation 302. A discovery function is then performed wherein the HC host device informs the TSD that it is highly capable in discovery operation 304. As a reciprocal part of this operation, the HC host may learn whether the TSD offers a metadata database and further whether the TSD supports block address logging. This type of discovery informs the host device whether the host device will be able to update a metadata database at all, whether the update must be performed by parsing the entire storage volume on the TSD, or whether the TSD supports a block address log enabling change-based updating of the metadata database. Additionally, the HC host device performs an authentication routine with the TSD to determine whether the host device is authorized to access the data files on the storage volume and/or the metadata database as indicated in authentication operation 306. Authentication may be performed using certificates, passwords, or other forms of authentication provided by the host device for comparison to certificates or other challenge information held by the TSD.

Once authentication of the host device is confirmed by the TSD, the HC host device may access the log on the TSD to identify any block address changes found in the log to the metadata updater application in the host device in a read/inspect operation 308. Once the log data is received, the metadata updater application reads only those data files on the storage volume that are new or modified in order to extract and synthesize metadata for each of the new or changed files as indicated in extract and synthesize operation 310. Upon creation of the metadata, the metadata updater writes the new metadata to the metadata database and modifies existing metadata therein as appropriate in writing operation 312. Once the metadata database is updated, the metadata updater may instruct the firmware on the TSD to flush the log so that only new changes to the data files on the storage volume will be subject to future updates.

After updating the metadata database, the HC host device may access the information in the metadata database as part of normal operations to provide the metadata to a user of the host device as indicated in query operation 316. Because only changes to the metadata that occurred since a prior update by an HC host device were performed, the response time to provide a user with completely up to date metadata information is extremely fast; depending upon the number of changes, in most instances the time required for the updating operation would likely be unnoticeable to a user. The HC host device may further read or write data to the storage area while the host device is connected with the TSD as indicated in read/write operation 318. In order to maintain a current metadata database, the process 300 may cycle back to read and inspect the log file as in operation 308 to record the changes made by the HC host device during the current session in the metadata database. Once all changes to the data files have been reflected in the metadata database, the HC device may disconnect from the TSD in disconnect operation 320.

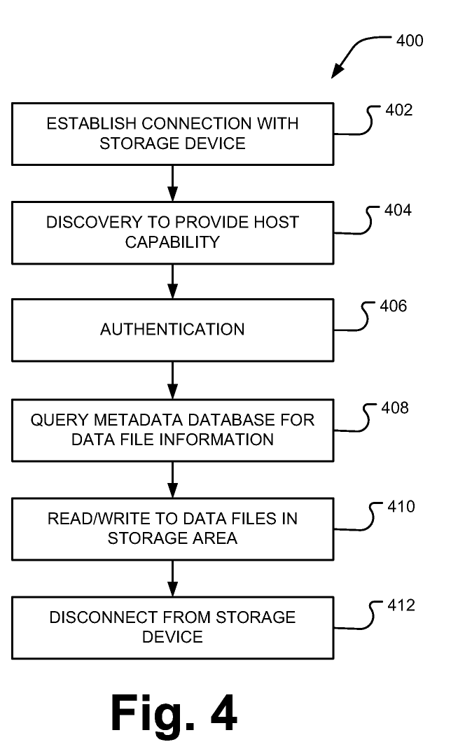

An alternate exemplary process 400 performed by an LC host device when connected with a TSD is depicted in FIG. 4. As an initial matter, when the LC host device is physically connected with the TSD, a communication connection is established in establishing operation 402. A discovery function is then performed wherein the LC host device informs the TSD that it is a less capable device in discovery operation 404. As a reciprocal part of this operation, the LC host may learn whether the TSD offers a metadata database and further whether the TSD supports block address logging. Additionally, the LC host device may perform an authentication routine with the TSD to determine whether the host device is authorized to access the data files on the storage volume and/or the metadata database as indicated in authentication operation 406. Authentication may be performed using certificates, passwords, or other forms of authentication provided by the host device for comparison to certificates or other challenge information held by the TSD. Alternatively the TSD may allow read-only access to the data files and/or metadata database if the LC host device has not successfully performed the authentication routine with the TSD.

Once the host device is authenticated to the TSD, the LC host device may access the information in the metadata database as part of normal operations to provide the metadata to a user of the host device as indicated in query operation 408. The LC host device may further read or write data to the storage area while the host device is connected with the TSD as indicated in read/write operation 410. Since the LC host device does not have the capability to parse the log or write to or modify a metadata database, the locations of changes made by the LC host device to the data files on the storage volume of the TSD will be recorded in the block address log. In this manner, the next time the TSD is connected with a HC host device, all the prior changes to the data files made by the LC host device will be captured and covered in a future modification to the metadata database by an HC host device. Once all desired changes to the data files have been made by the LC host device, the LC host device may disconnect from the TSD in disconnect operation 412.

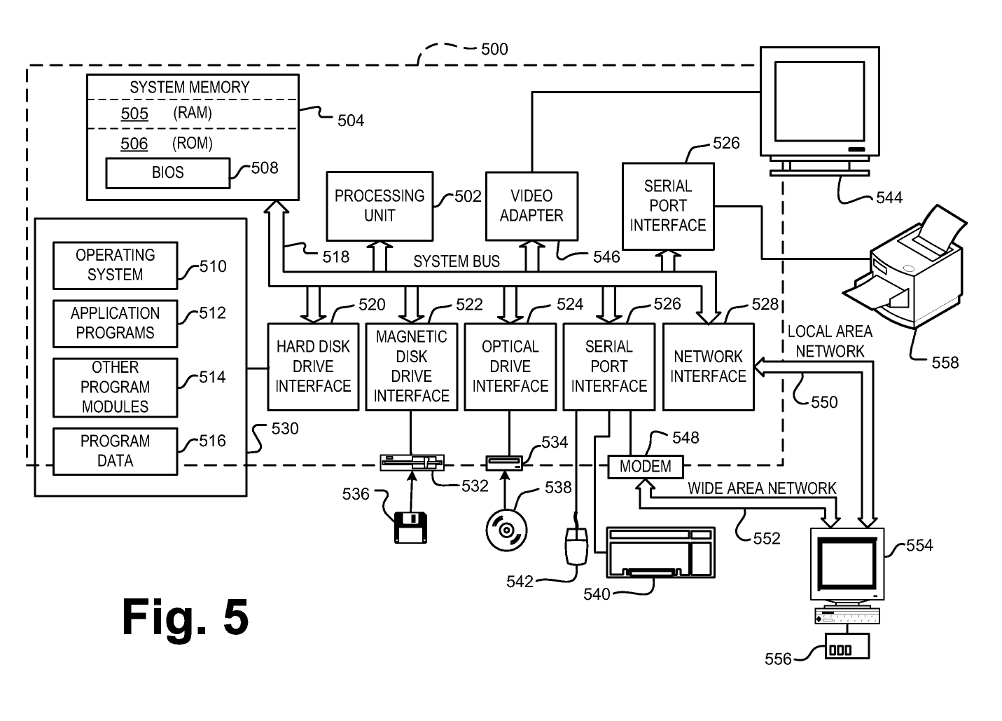

A schematic diagram of a general purpose computing device 500 that may operate as a host computer device to a TSD is depicted in FIG. 5. The exemplary hardware and operating environment for the host computing device may include a processing unit 502, a system memory 504, and a system bus 518 that operatively couples various system components, including the system memory 504 to the processing unit 502. There may be one or more processing units 502, such that the processor of computer 500 comprises a single central processing unit (CPU), or a plurality of processing units, commonly referred to as a parallel processing environment. The computer 500 may be a conventional computer, a distributed computer, or any other type of computer.

The system bus 518 may be any of several types of bus structures including a memory bus or memory controller, a peripheral bus, a switched fabric, point-to-point connections, and a local bus using any of a variety of bus architectures. The system memory 504 may also be referred to as simply the memory and includes read only memory (ROM) 506 and random access memory (RAM) 505. A basic input/output system (BIOS) 508, containing the basic routines that help to transfer information between elements within the computer 500, such as during start-up, is stored in ROM 506. The computer 500 further includes a hard disk drive 530 for reading from and writing to a hard disk, not shown, a magnetic disk drive 532 for reading from or writing to a removable magnetic disk 536, and an optical disk drive 534 for reading from or writing to a removable optical disk 538 such as a CD ROM or other optical media.

The hard disk drive 530, magnetic disk drive 532, and optical disk drive 534 are connected to the system bus 518 by a hard disk drive interface 520, a magnetic disk drive interface 522, and an optical disk drive interface 524, respectively. The drives and their associated computer-readable media provide nonvolatile storage of computer-readable instructions, data structures, program modules and other data for the computer 500. It should be appreciated by those skilled in the art that any type of computer-readable media that can store data that is accessible by a computer, for example, magnetic cassettes, flash memory cards, digital video disks, RAMs, and ROMs, may be used in the exemplary operating environment.

A number of program modules may be stored on the hard disk 530, magnetic disk 532, optical disk 534, ROM 506, or RAM 505, including an operating system 510, one or more application programs 512, other program modules 514, and program data 516. In an exemplary implementation, programs for communication and data transfer with the TSD, including the metadata updater application, may be incorporated as part of the operating system 510 (e.g., as part of an application protocol interface (API)), discrete application programs 512, or other program modules 514.

A user may enter commands and information into the personal computer 500 through input devices such as a keyboard 540 and pointing device 542, for example, a mouse. Other input devices (not shown) may include, for example, a microphone, a joystick, a game pad, a tablet, a touch screen device, a satellite dish, a scanner, a facsimile machine, and a video camera. These and other input devices are often connected to the processing unit 502 through a serial port interface 526 that is coupled to the system bus 518, but may be connected by other interfaces, such as a parallel port, game port, or a universal serial bus (USB).

A monitor 544 or other type of display device is also connected to the system bus 518 via an interface, such as a video adapter 546. In addition to the monitor 544, computers typically include other peripheral output devices, such as a printer 558 and speakers (not shown). These and other output devices are often connected to the processing unit 502 through the serial port interface 526 that is coupled to the system bus 518, but may be connected by other interfaces, such as a parallel port, game port, or a universal serial bus (USB). A media tuner module 560 may also be connected to the system bus 518 to tune audio and video programming (e.g., TV programming) for output through the video adapter 546 or other presentation output modules.

The computer 500 may operate in a networked environment using logical connections to one or more remote computers, such as remote computer 554. These logical connections may be achieved by a communication device coupled to or integral with the computer 500; the invention is not limited to a particular type of communications device. The remote computer 554 may be another computer, a server, a router, a network personal computer, a client, a peer device, or other common network node, and typically includes many or all of the elements described above relative to the computer 500, although only a memory storage device 556 has been illustrated in FIG. 5. The logical connections depicted in FIG. 5 include a local-area network (LAN) 550 and a wide-area network (WAN) 552. Such networking environments are commonplace in office networks, enterprise-wide computer networks, intranets and the Internet, which are all types of networks.

When used in a LAN 550 environment, the computer 500 may be connected to the local network 550 through a network interface or adapter 528, e.g., Ethernet or other communications interfaces. When used in a WAN 552 environment, the computer 500 typically includes a modem 548, a network adapter, or any other type of communications device for establishing communications over the wide area network 552. The modem 548, which may be internal or external, is connected to the system bus 518 via the serial port interface 526. In a networked environment, program modules depicted relative to the personal computer 500, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing encoded computer program instructions executable by a computer system. Another implementation of a computer program product may be provided in a computer data signal embodied in a carrier wave by a computing system and encoding the computer program. Other implementations are also described and recited herein.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method on a storage device for maintaining an exo-file system metadata database of information about data stored on a storage volume of the storage device, the method comprising
establishing a connection with a host device;
discovering a capability of the host device to update the metadata database;
logging addresses corresponding to storage locations of changes made to the data on the storage volume; and
providing discovery to the host device regarding an availability of the metadata database and a log of addresses corresponding to storage locations of changes made to the data on the storage volume.

2. The method of claim 1, further comprising authenticating the host device to authorize an update to the storage volume and the metadata database.

3. The method of claim 1 further comprising
receiving changes to the metadata database from the host device based upon the log of addresses; and
reading, writing, and modifying the metadata database pursuant to the received changes.

4. The method of claim 3, further comprising clearing the log of addresses after completion of the reading, writing, and modifying operation.

5. The method of claim 3, wherein
the providing discovery operation further comprises providing a subset of the log of addresses pursuant to direction of the host device; and
the method further comprises clearing the subset of the log of addresses after completion of the reading, writing, and modifying operation.

6. The method of claim 1 further comprising
receiving changes to the data on the storage volume from the host device; and
reading, writing, and modifying the data on the storage volume pursuant to the received changes.

7. A method on a host computer device connected with a storage device for maintaining an exo-file system metadata database of information about data stored on a storage volume of the storage device, the method comprising
establishing a connection with a storage device;
providing discovery to the storage device regarding a capability to update the metadata database;
receiving discovery from the storage device about an availability of the metadata database and a log of addresses corresponding to storage locations of changes made to the data on the storage volume;
reading the log of addresses to identify the storage locations of changed data on the storage volume;
extracting metadata from changed data found at the identified storage locations; and
instructing the storage device to update the metadata database with the extracted metadata.

8. The method of claim 7 further comprising receiving an authentication confirmation from the storage device authorizing the update to the metadata database.

9. The method of claim 7 further comprising instructing the storage device to clear the log of addresses after completion of the reading, writing, and modifying operation.

10. The method of claim 7, wherein
the reading operation further comprises filtering the log of addresses to identify a subset of the storage locations of changed data; and
the extracting operation further comprises extracting metadata from a subset of the changed data corresponding to the subset of the storage locations.

11. The method of claim 10 further comprising instructing the storage device to clear a subset of the log of addresses corresponding to the subset of the storage locations after the storage device completes updating the metadata database.

12. The method of claim 7 further comprising
copying the metadata database from the storage device; and
storing the copied metadata database on the host computer system.

13. The method of claim 7 further comprising instructing the storage device to write changes to the data on the storage volume.

14. A computer-readable medium storing computer-executable instructions for performing a computer process on a host computer device connected with a storage device to maintain an exo-file system metadata database of information about data stored on a storage volume of the storage device, wherein the instructions comprise operations to
establish a connection with a storage device;
provide discovery to the storage device regarding a capability to update the metadata database;
receive discovery from the storage device about an availability of the metadata database and a log of addresses corresponding to storage locations of changes made to the data on the storage volume;
read the log of addresses to identify the storage locations of changed data on the storage volume;
extract metadata from changed data found at the identified storage locations; and
instruct the storage device to update the metadata database with the extracted metadata.

15. The computer-readable medium of claim 14, wherein the instructions further comprise operations to receive an authentication confirmation from the storage device authorizing the update to the metadata database.

16. The computer-readable medium of claim 14, wherein the instructions further comprise operations to instruct the storage device to clear the log of addresses after completion of the reading, writing, and modifying operation.

17. The computer-readable medium of claim 14, wherein
the reading operation further comprises operations to filter the log of addresses to identify a subset of the storage locations of changed data; and
the extracting operation further comprises operations to extract metadata from a subset of the changed data corresponding to the subset of the storage locations.

18. The computer-readable medium of claim 17, wherein the instructions further comprise operations to instruct the storage device to clear a subset of the log of addresses corresponding to the subset of the storage locations after the storage device completes updating the metadata database.

19. The computer-readable medium of claim 14, wherein the instructions further comprise operations to
copy the metadata database from the storage device; and
store the copied metadata database on the host computer system.

20. The computer-readable medium of claim 14, wherein the instructions further comprise operations to instruct the storage device to write changes to the data on the storage volume.
